(19) United States
(12) Patent Application Publication
(10) Pub. No.: US 2012/0172082 A1
(43) Pub. Date: Jul. 5, 2012

(54) MOBILITY DETECTION AND REPORTING SYSTEM AND METHOD FOR DETECTING AND REPORTING CELL CHANGES OF A MOBILE TERMINAL IN A MOBILE TELECOMMUNICATION NETWORK

(75) Inventors: Daniele Abbadessa, Heidelberg (DE); Joerg Swetina, Schriesheim (DE)

(73) Assignee: NEC EUROPE LTD., Heidelberg (FR)

(21) Appl. No.: 13/388,761

(22) PCT Filed: Aug. 3, 2009
(86) PCT No.: PCT/EP2009/005603

§ 371 Date: Mar. 15, 2012

(51) Int. Cl. H04W 68/00; H04W 60/04

(52) U.S. Cl. 455/524

(57) ABSTRACT

A mobility detection and reporting system for detecting and reporting cell changes of a mobile terminal (100) in a mobile telecommunication network is characterized in that the system includes an terminal-application (101) residing on the mobile terminal (100), and a service notification system (400) provided in the network, wherein the terminal-application (101) is configured to report specific cell changes of the mobile terminal (100) to the service notification system (400), and wherein the service notification system (400) is configured to notify service applications (600) in the network about the cell changes of the mobile terminal (100). Furthermore, a respective method for supporting cell changes of a mobile terminal (100) in a mobile telecommunication network is disclosed.

The present invention relates to a mobility detection and reporting system and a method for detecting and reporting cell changes of a mobile terminal in a mobile telecommunication network.

Currently, in many cellular mobile telecommunication networks (e.g. 3GPP, WiMAX, or 3GPP2), a mobile terminal does not always inform the network when it selects a different cell due to its mobility in the network. In particular in idle mode (i.e. when a mobile terminal does not exchange user traffic with the network) a mobile terminal may camp on a new cell without the network noticing it. E.g. in 3GPP, a mobile terminal, which is typically referred to as UE (user equipment), in idle mode performs a cell reselection procedure within the same Location Area as the old cell without sending a notification message (e.g. a “Location Update” message) to the network. While in general this is desired behavior, which reduces signaling traffic during mobility events, in the context of cell related services, like e.g. Femtocell services or “Local IP Access & Internet Offload” (LIPA), this imposes a severe restriction.

More specifically, in 3GPP a new concept has been specified that introduces an in-home, evolved node B for LTE (Long Term Evolution) networks, which is referred to as H(e)NB and an in-home node B (referred to as HNB) for 3GPP UTRAN (UMTS Terrestrial Radio Access Network) access. In the following, both node Bs will be denoted equally as H(e)NB. In contrast to conventional cell sites, the user access provided by H(e)NBs extends over a rather small (in-house) area only, typically limited to homes or even single rooms.

For H(e)NBs, but also for conventional types of base stations that are capable of LIPA, new services may be designed that should only be available to UEs that are actually camping on these cells. An example may be a service that synchronizes data of a family member's UE with a PC in the house, once the family member returns home. This could be triggered when the family member's UE enters the cell of the H(e)NB in the home of the family. For these kind of services an accurate and reliable reporting mechanism is needed to inform the network on which cell a particular UE camps. While of course this information is available in the UE the network—and network based services—in many cases will not receive such information.

Currently, in special cases the problems as outlined above can be circumvented by specific network configuration (e.g. by a specific allocation of location areas). However, this imposes a severe restriction on the operator's network planning and leads to additional signaling load.

It is therefore an objective of the present invention to develop a mobility detection and reporting system and a method for reporting specific cell changes of a mobile terminal in a mobile telecommunication network in such a way that service applications in the network are informed about mobility events of mobile terminals in an efficient and reliable way.

In accordance with the invention, the aforementioned object is accomplished by a mobility detection and reporting system comprising the features of claim 1. According to this claim such a system is characterized in that the system comprises a terminal-application residing on said mobile terminal, and a service notification system provided in said network, wherein said terminal-application is configured to report specific cell changes of said mobile terminal to said service notification system, and wherein said service notification system is configured to notify service applications in the network about said cell changes of said mobile terminal.

Furthermore, the aforementioned object is accomplished by a method comprising the features of independent claim 10. According to this claim, such a method is characterized in providing a terminal-application residing on said mobile terminal, said terminal-application being configured to report specific cell changes of said mobile terminal to a service notification system provided in said network, wherein said service notification system notifies service applications about said cell changes of said mobile terminal.

According to the invention it has been recognized that there are cases in which it is desirable that the event of a mobile terminal entering or leaving a cell is reported to service applications in the network that provide services to the mobile terminal. However, currently such events cannot be detected by the network in many cases. To this end the present invention proposes the deployment of a dedicated terminal-application implemented on the side of the mobile terminal together with the deployment of a service notification system implemented in the network. According to the invention the terminal-application reports entry to and exit from specific cells, a mobile terminal camps on, to the service notification system. The service notification system notifies service applications (that provide services to the mobile terminal) of mobility events reported by the terminal-application that resides on the mobile terminal.

The system and the method according to the present invention can be applied to many types of cellular mobile telecommunication networks, for instance but not limited to 3GPP, WiMAX, and 3GPP2. It is to be noted that the proposed solution can also support “old” terminals, e.g. pre-3GPP Rel-8 terminals. The proposed solution is particularly advantageous in that it does not rely on a specific network configuration (e.g. Location Area allocation) nor particular H(e)NB capabilities. Moreover, also with respect to the kind of cells that are supported the present invention does not rely on any network specific restrictions and/or configurations. The present solution is applicable to mobility events related to (normal) macro cells as well as to Femto cells or the like. It is also worth mentioning that in the light of the current discussion in 3GPP on “Local IP Access & Internet Offload” (LIPA) the method according to the present invention can be applied without having to undertake any changes.

When referred to “mobile terminal” hereafter, this terminology includes but is not limited to a user equipment (UE), a mobile phone, a handset, a PDA (personal digital assistant), a computer, or any other user device capable of operating in a cellular mobile telecommunication network. According to a preferred embodiment the terminal-application may reside on the hardware of the mobile terminal, in particular as an executable program of said mobile terminal. In this case it is assumed that the terminal-application has access to the mobility management related information of the mobile terminal (e.g. the cell identifiers). Alternatively, with respect to higher flexibility it may be provided that the terminal-application resides on a removable entity of the mobile terminal. For instance, in case of 3GPP the terminal-application may reside as a USIM (Universal Subscriber Identity Module) Application Toolkit (USAT) application on the UICC (Universal Integrated Circuit Card). In any case, it may be provided that the terminal-application may either be pre-installed on mobile terminals or that it is pushed to the mobile terminal by the operator.

With respect to an effective notification of the terminal-application of mobility events of the mobile terminal it resides on, it may be provided that the terminal-application receives respective information from the mobile terminal via the mobile terminal's RR (Radio Resource management) layer. For instance, in case the mobile terminal changes from one cell—old cell—to another cell—new cell—, the terminal-application is notified by the RR layer of the mobile terminal of the cell identifier of the new cell. Such notification may be automatically generated each time the mobile terminal camps on a new cell. Alternatively, it may be provided that the terminal-application is configured to query the RR layer to get the cell identifier of the new cell. With respective to a more comprehensive information exchange it may be provided that the terminal-application is configured to report additional parameters (e.g. femtocell IDs) to the service notification system.

With respect to avoid unnecessary traffic the terminal-application may be configurable to report only selected cell changes of the mobile terminal to the service notification system. By this means only those cell changes are reported that are relevant to the services, implemented by service applications in the network, which are provided to the user. According to a further embodiment the service notification system includes a database, wherein the database contains a mapping between a one or more cells and a list of service applications that should be notified in case of the terminal-application in a mobile terminal reports cell changes to/from those cells. Notification of the service application includes an identity of the mobile terminal that reported the cell change. Apart from the mapping mentioned above the database may include additional information that describes filtering conditions that need to be met when a mobility event of a mobile terminal should be reported to the service application. This information may include for example, but not limited to, a whitelist/blacklist of mobile terminals, whose mobility events should/should not be reported, a list of cells a particular mobile terminal is allowed to enter/employ (e.g. identified by their cell IDs), cell properties (e.g. femto-cells), Closed Subscriber Groups, etc. Mobility related information provided to the service notification system may also be supplemented by information provided by other entities in the operator's core network. E.g. in the event of a cell change in active mode (handover) the network may provide information about the active sessions.

With respect to an effective deployment the service notification system may include an application registration and notification platform. This platform may include an application registration portal that enables service applications to register for receiving notifications on mobility events and to specify related filtering conditions that need to be met. For security reasons it may be desirable to make information on mobility events of a mobile terminal available to authorized services only. To this end the portal may be configured in such a way that the reception of notifications by a service application requires successful authentication and authorization of that service application. Conventional authentication, authorization and registration procedures as known in the state of the art may be implemented.

Further, the application registration and notification platform may include an application notification platform that is configured to notify registered service applications about cell changes of mobile terminals. According to one embodiment the application notification platform may be configured to report all cell changes of a mobile terminal without any exceptions. Alternatively it may be provided that only selected cell changes are reported, wherein the selection process may be controlled by the filtering conditions of the aforementioned database, by the application notification platform itself or by another entity. Additional information may be included into the notification process, i.e. the application notification platform may be configured to provide, depending on the respective selection rules, additional information related to mobility events. This information may include, but not limited to, e.g. in case of 3GPP: Mobile Subscriber Identity, Cell Identity, H(e)NB Name, CSG ID, etc.

With respect to an enhanced user experience the service notification system may include a user self-configuration portal that facilitates a user of a mobile terminal to register which service applications are allowed to receive notifications on mobility events of said mobile terminal. Consequently, even if the application notification platform is configured to notify all registered service applications about cell changes of a mobile terminal, the user can quasi block notifications to certain service applications according to his current needs and requirements. Additionally, the user may customize the service behavior of specific service applications through the user self-configuration portal. Moreover, in cases the terminal-application is not preinstalled on the mobile terminal, the first access of the mobile terminal to the user self-configuration portal may be employed as a trigger for downloading the terminal-application to the mobile terminal.

There are several ways how to design and further develop the teaching of the present invention in an advantageous way. To this end, it is to be referred to the patent claims subordinate to patent claims 1 and 10 on the one hand, and to the following explanation of a preferred example of an embodiment of the invention illustrated by the drawing on the other hand. In connection with the explanation of the preferred example of an embodiment of the invention by the aid of the drawing, generally preferred embodiments and further developments of the teaching will be explained. In the drawings

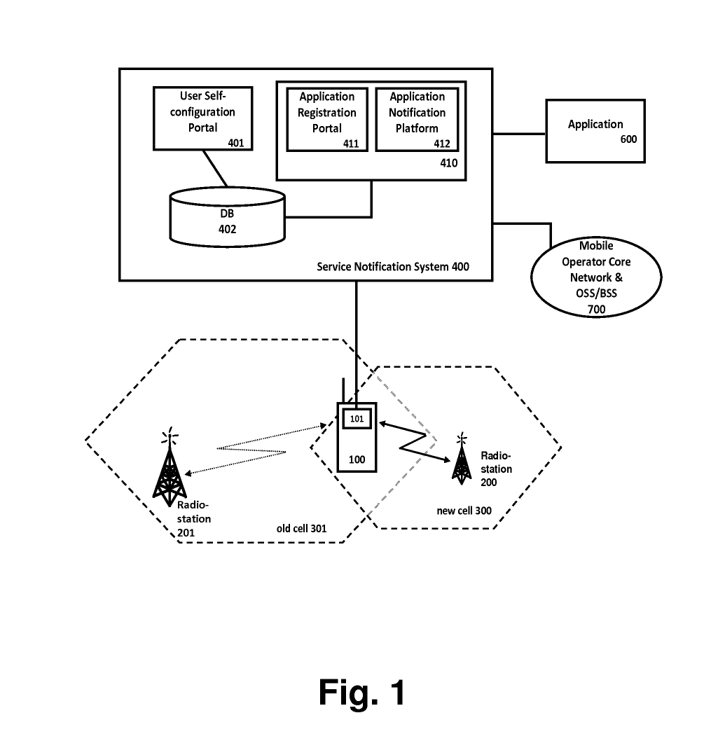

FIG. 1 schematically illustrates a mobility detection and reporting system according to one embodiment of the present invention, and

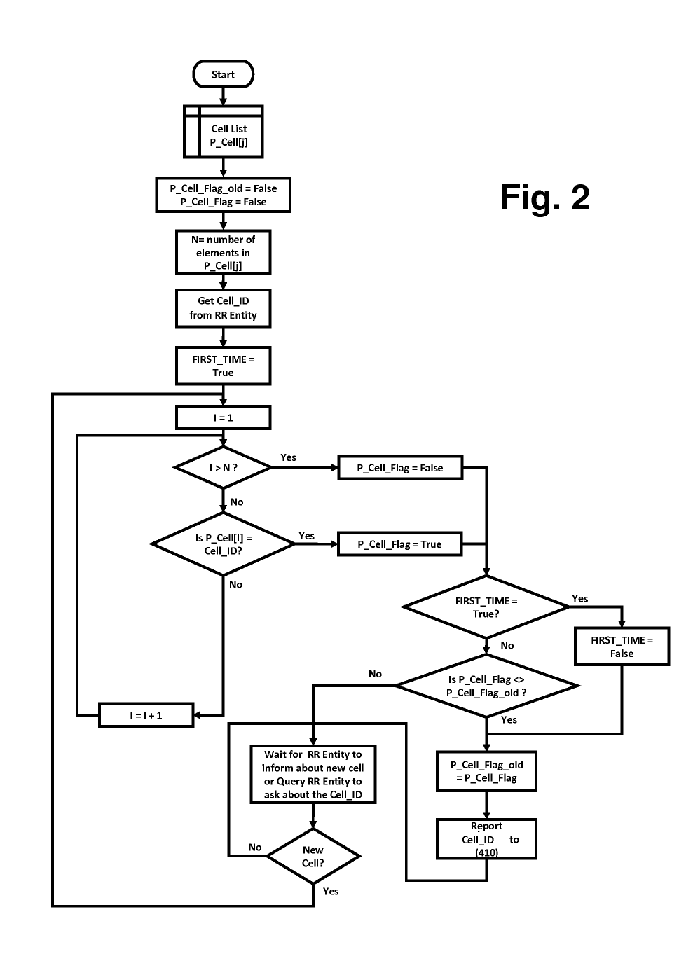

FIG. 2 is a flow diagram of an exemplary algorithm that is running in the terminal-application residing on the mobile terminal as shown in FIG. 1.

In the scenario illustrated in FIG. 1, mobile terminal 100 changes its location within the network. More specifically, mobile terminal 100 gradually leaves the coverage area of radio station 201 that operates cell 301 (referred to as old cell 301), and enters the coverage area of radio station 200 that operates cell 300 (in the follow referred as new cell 300). If Cell 300 and 301 belong to the same location area, the network does not notice that mobile terminal 100 has left the old cell 301 and camps on new cell 300. In particular in the context of femtocell services such behavior may be critical for activating femto-specific service applications.

According to the present invention a terminal-application 101 is introduced that resides on the mobile terminal 100. Although not apparent from FIG. 1, it is assumed for the illustrated example that terminal-application 101 is implemented as an executable program of the mobile terminal's 100 operational system or, alternatively, the terminal-application 101 resides on a removable entity of the mobile terminal 100.

The terminal-application 101 is notified by the RR (Radio Resource Management) layer of the mobile terminal 100 (e.g. 3GGP 44.018) on the new cell identifier every time the mobile terminal 100 camps on a new cell. In the example illustrated in FIG. 1, upon entry of the mobile terminal 100 into the coverage area of radio station 200, the terminal-application 101 is notified of the cell identifier of new cell 300. It is noted that the notification takes place independent of whether the mobile terminal 100 selects a new cell in idle mode or in a connected mode.

The terminal-application 101 is configured to report specific cell changes of which it has been notified, e.g. via the mobile terminal's 100 RR layer, to a Service Notification System (SNS) 400 in the network. The terminal-application 101 may be configured to report only selected cell changes of the mobile terminal to the SNS (400). The SNS 400 is connected to the operator's core network and is managed and configured by the operator's OSS/BSS (Operations Support System/Business Support System) system 700. It notifies authorized and registered service applications 600 about the cell changes of the mobile terminal 100.

In the following the SNS 400 is described in some more detail. The SNS 400 includes a database 402 and an Application Registration & Notification Platform 410. The database 402 contains for each registered mobile terminal a mapping between a set of cells (characterized by cell identifiers) and a list of service applications (600) that should be notified in case of the terminal-application in a mobile terminal reports cell changes to/from one of the cells. Notification of the service application includes the cell identifier and an identity of the mobile terminal that reported the cell change.

Apart from the mapping mentioned above the database may include additional information that describes filtering conditions that need to be met when a mobility event of a mobile terminal should be reported to the service application.

This additional information may include for example, but not limited to, a whitelist/blacklist of mobile terminals, whose mobility events should/should not be reported, cell properties (e.g. femto-cells), Closed Subscriber Groups, etc.

In the database mobile terminals may e.g. be identified by a mobile subscriber identity. The service applications 600 may also be identified by a specific application identifier.

The list of service applications 600 that is contained in the database 402 can be specified in different ways. In the case shown in FIG. 1, platform 410 includes an application registration portal 411 that enables service applications 600—after successful authorization and authorization—to register for receiving notifications on mobility events of a mobile terminal. Service applications 600 registered with the application registration portal 411 may then be incorporated in the list of service applications 600 contained in the database 402. As regards the authentication and authorization process conventional methods may be employed. In addition to a registration for receiving mobility related notifications, application registration portal 411 enables service applications to specify related conditions that need to be met.

Platform 410 further includes an application notification platform 412 which notifies registered applications about mobility events of mobile terminals. Moreover, the application notification platform 412 may provide additional information related to these mobility events. For instance, in case of 3GPP the additional information may include a Mobile Subscriber Identity, a Cell Identity, the H(e)NB Name, CSG (Closed Subscriber Group) ID, or the like.

The SNS 400 of the exemplary mobility detection and reporting system as illustrated in FIG. 1 further includes a user self-configuration portal 401. By employing this portal the user can register which service applications 600 are allowed to receive notifications on mobility events of his mobile terminal. Additionally, the user may customize service behavior of the service application through the user self-configuration portal 401. Consequently, the user, within the limits set by the operator, has full control over the system and he can make his own decisions on which service applications to exclude from the notifications.

FIG. 2 is a flow diagram of an example of an algorithm that is running in the terminal-application 101 described in connection with FIG. 1. It is assumed that a list of cells is stored in the terminal-application 101. This list of cells refers to those cells the terminal-application 101 must report to the SNS 400 every time the mobile terminal enters or leaves these specific cells. This list of cells is denoted P_Cell[j]. The number of elements in this list is denoted with N.

In the beginning, a flag P_Cell_Flag_old and a flag P_Cell_Flag are both set to “False”. Another variable denoted FIRST_TIME indicating whether the routine is executed for the first time or not is set to “True”. Once the terminal-application 101 is launched, it reads from the RR entity the Cell_ID of the cell the mobile terminal is currently camped on. The term Cell_ID refers to a unique network specific cell identifier.

In the next step the terminal-application 101 checks whether the current cell ID matches with one of the cells from the cell list P_Cell[j]. Based on the result of this confront, the terminal-application 101 will set the flag P_Cell_Flag to “True” or “False”. If the terminal-application 101 is launched for the first time, the result of this test will be passed to the SNS 400. More specifically, the Cell_ID value will be reported to the application registration and notification platform 410. Afterwards, the terminal-application 101 is informed by the RR entity or periodically queries the RR entity about cell changes. Only changes of the Cell_ID to/from a cell of the stored list of cells, will be reported back to the SNS 400.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Mobility detection and reporting system for detecting and reporting cell changes of a mobile terminal (100) in a mobile telecommunication network,
characterized in that the system comprises
a terminal-application (101) residing on said mobile terminal (100), and a service notification system (400) provided in said network,
wherein said terminal-application (101) is configured to report specific cell changes of said mobile terminal (100) to said service notification system (400), and
wherein said service notification system (400) is configured to notify service applications (600) in the network about said cell changes of said mobile terminal (100).

2. System according to claim 1, wherein said terminal-application (101) resides on the hardware of said mobile terminal (100), in particular as an executable program of said mobile terminal (100).

3. System according to claim 1, wherein said terminal-application (101) resides on a removable entity of said mobile terminal (100).

4. System according to claim 1, wherein said terminal-application (101) resides on said mobile terminal's (100) UICC as an application of the USAT (USIM Application Toolkit).

5. System according to claim 1, wherein said service notification system (400) includes a database (402), said database (402) containing a mapping between a list of cells and a list of applications (600) that should be notified in case of cell changes of said mobile terminal (100) to/from one of the cells in the list of cells.

6. System according to claim 5, wherein the database (402) contains filtering conditions, wherein mobility events are reported to said service applications (600) only in case said filtering conditions are met.

7. System according to claim 1, said service notification system (400) includes an application registration portal (411) that enables applications (600) to register for receiving notifications on mobility events.

8. System according to claim 1, said service notification system (400) includes an application notification platform (412) that is configured to notify registered applications (600) about cell changes of said mobile terminal (100).

9. System according to claim 1, said service notification system (400) includes a user self-configuration portal (401) that facilitates a user of said mobile terminal (100) to register which applications (600) are allowed to receive notifications on mobility events of said mobile terminal (100).

10. Method for detecting and reporting cell changes of a mobile terminal (100) in a mobile telecommunication network, characterized in
providing a terminal-application (101) residing on said mobile terminal (100),
said terminal-application (101) being configured to report specific cell changes of said mobile terminal (100) to a service notification system (400) provided in said network,
wherein said service notification system (400) notifies service applications (600) in the network about said cell changes of said mobile terminal (100).

11. Method according to claim 10, wherein said terminal-application (101) resides on the hardware of said mobile terminal (100), in particular as an executable program of said mobile terminal (100).

12. Method according to claim 10, wherein said terminal-application (101) resides on a removable entity of said mobile terminal (100).

13. Method according to claim 10, wherein said terminal-application (101) resides on said mobile terminal's (100) UICC as an application of the USAT (USIM Application Toolkit).

14. Method according to claim 10, wherein said terminal-application (101), in case of said mobile terminal (100) changing from an old cell (301) to a new cell (300), is notified by the RR layer of said mobile terminal (100) of the cell identifier of said new cell (300).

15. Method according to claim 10, wherein said terminal-application's (101) report of a cell change of said mobile terminal (100) from an old cell (301) to a new cell (300) includes the cell identifier of said new cell (300).

16. Method according to claim 15, wherein said terminal-application (101) is configured to report additional parameters to said service notification system (400).

17. Method according to claim 10, wherein said terminal-application (101) is configured to report only selected cell changes of said mobile terminal (100) to said service notification system (400).

18. Method according to claim 11, wherein said terminal-application (101) resides on a removable entity of said mobile terminal (100).

19. System according to claim 2, wherein said terminal-application (101) resides on a removable entity of said mobile terminal (100).
